(19) United States
(12) Patent Application Publication
(10) Pub. No.: US 2006/0104085 A1
(43) Pub. Date: May 18, 2006

(54) Power tool with illumination device

(76) Inventors: Andrew Walker, Newton Hall (GB); Stephen Houghton, High West Jesmond (GB)

Correspondence Address: Bruce S. Shapiro;Sr. Group Patent Counsel, Black & Decker Corporation, 701 E. Joppa Rd., Mail Stop TW199, Towson, MD, 21286, US

(21) Appl. No.: 11/280,050

(22) Filed: Nov. 16, 2005

(30) Foreign Application Priority Data
Nov. 17, 2004 (GB) GB 0425279.7

(51) Int. Cl. B25B 23/18; F21V 8/00

(52) U.S. Cl. 362/578; 362/120

(57) ABSTRACT

A power tool, such as a screwdriver is described, which comprises an illumination device 18 for illuminating a work region. The illumination device is disposed on the front face of the screwdriver's gearbox to achieve this aim. Also provided is an extension piece 22 which is attachable to the front of the screwdriver. A central prop-shaft 24 engages with the spindle 16 when the extension piece is attached to the screwdriver. A waveguide 40 is provided to guide light emitted by the illumination device(s) so as to provide sufficient illumination of a work region when the extension piece is attached to the screwdriver. The light is emitted from the waveguide in a direction which is generally axial to the axis of rotation of the extension's drive output 28. The screwdriver is operable in two modes, with or without the extension and sufficient illumination of a work region is provided in both modes.

### FIELD OF THE INVENTION

The present invention relates to a power tool, preferably a hand-operated motor driven screwdriver, which includes an illumination device arranged to illuminate a region of work relatively close to the power tool output.

### BACKGROUND OF THE INVENTION

Embodiments of the present invention are described below with reference to a screwdriver. However, it is to be understood that the invention is not limited to such tools, and can be equally applied to any other type of power tools.

In certain circumstances it may be desirable to illuminate a region of work, perhaps because the region is in a dark or shaded area and it is difficult for a user to see the work region. This can be achieved by using flashlight to illuminate the work region. However, a flashlight might not be easily to hand for a workman, who may have to leave the area in order to fetch the flashlight.

This particular problem has been addressed by providing an illumination device on a manually driven screwdriver, thus providing a combination illumination device and screwdriver which may prevent the need for a separate flashlight to illuminate a work region. For instance, GB2272967 describes a manually operated screwdriver which comprises a sleeve of light-transmitting material around the shank, and a bulb for illuminating the end of the sleeve in or adjacent to the handle, so that light is transmitted along the length of the sleeve to the work region adjacent to the operating bit of the tool.

GB2350812 describes a screwdriver having a light shade installed in a non-circular socket of the front end of a grip. A bulb is disposed in the light shade. A seat of a transparent sleeve is engaged in the non-circular socket. The front end of the sleeve is formed with a tool connecting section for engaging with a screwdriver head. A switch allows the user to control the bulb so as to provide an illumination for the work.

U.S. Pat. No. 4,936,171 describes a illuminating screwdriver attachment, the base of which attaches to a light source, such as a torch or flashlight. A shank is attached to the base and is made of light transmissive material so that light from the torch is delivered to a blade.

U.S. Pat. No. 6,030,090 describes a screwdriver with illumination, comprising a handle, a battery, a bulb, and a tool receiving part having grooves which serve to guide light from the bulb around a tool bit.

It is known to have illuminating devices on motor driven power tools. For instance, U.S. Pat. No. 2,310,116 describes a lighting device for a portable electric tool. The lighting device is disposed on the gearbox housing and arranged to illuminate the field of operation of the tool. A similar arrangement is described in U.S. Pat. No. 5,445,479. However, because the light has to be directed from a source which is off-set from power tool's axis of operation, there is a limited region in which the illuminating beam coincides with the region of work; the illuminating beam crosses the axis of operation, or the axis about which the tool bit rotates during use. This might be overcome by providing a relatively divergent beam from the illuminating device. However, the intensity of light rapidly depletes as the power tool is moved further away from the region of work.

### BRIEF SUMMARY OF THE INVENTION

Embodiments of the present invention aim to ameliorate the prior art and the problems described above, and other problems, by providing a hand-operated motor driven power tool, such as a screwdriver, which has an illumination device arranged to transmit light to a work region substantially along the power tool's axis of operation.

More precisely, the present invention provides a hand-operated motor driven tool, such as a screwdriver, comprising, a main body for housing a motor arranged to drive an output, such as a shaft or spindle, the output having receiving means disposed on an end furthest from the motor, the receiving means being arranged to receive a tool-bit, a light emitting device, such as an LED, disposed on or in the main body, and a waveguide arranged to guide a portion of light emitted by the light emitting device to a waveguide output, said waveguide output being disposed around or through the spindle such that the waveguide output is near to the receiving means, characterised in that, either the waveguide and output are arranged to rotate with respect to the main body during use, or the output is arranged to rotate during use with respect to the waveguide.

The present invention also provides a hand-operated motor driven tool, such as a screwdriver, comprising, a body for housing a motor arranged to drive an output, such as a shaft or spindle, the output having an axis of rotation and receiving means disposed on a first end of the output furthest from the motor, the receiving means being suitable to receive a tool-bit, and a light emitting device, such as an LED, arranged in or on the body, characterised in that the tool further comprises a waveguide arranged to guide a portion of light emitted by the light emitting device from a waveguide input to a waveguide output, the waveguide output being arranged such that light is emitted from the waveguide close to the receiving means and substantially along the output's axis of rotation for illumination of a work-piece or work region. The waveguide can be arranged around or through the output shaft. During use, the waveguide and output can rotate relative to the body. Alternatively, during use, the output can rotate relative to the waveguide. The tool-bit can comprise a screwdriver bit or a drill, for instance.

Thus, embodiments of the present invention have the advantage of providing a power tool with illumination means which can illuminate the work region no matter where the power tool is arranged with respect to the work region because the light is emitted along the axis of operation of the power tool. Furthermore, the use of a waveguide to transmit light from an LED or bulb on a power tool body to a position close to the tool-bit provides an arrangement which can increase the illumination level of the work region, particularly if the work region is relatively far from the LED or bulb. This is achieved by reducing losses of light and transmitting a relatively large portion of light from the illumination device to a focused emitting area at the end of the waveguide (which light may otherwise have been lost or become useless because it would not be illuminating the intended work region). Thus, the LED can be disposed in a position distal from the receiving means or work region; the waveguide being arranged to transmit the LED emissions to a position close to the work region.

Preferably, the waveguide is in the shape of a hollow tube. In other words, the waveguide has an annular cross-section. Thus, the waveguide can be disposed around the shaft. Furthermore, the shaft can be mounted on bearings to allow rotation of the shaft with respect to the waveguide. The bearings can be arranged to engage with the shaft and the inner surface of the waveguide. The bearings can be made of a plastic material, and the bearings can comprise a tubular shaped nylon sleeve arranged to guide the shaft as it rotates with respect to the waveguide.

Preferably, embodiments of the present invention can further comprise an extension arranged to be fixedly attached to the tool. The extension can comprise the shaft and waveguide, and a second end of the shaft furthest from the receiving means can be arranged to cooperate with an output spindle from the motor, or from a gearbox driven by the motor. The illuminating devices can be disposed on the gearbox housing so as to illuminate the work region when the extension is detached from the tool, or so as to illuminate the waveguide input when the extension is attached to the tool, thereby providing illumination of the work region via the waveguide.

Preferably, embodiments of the present invention can be arranged so that the output spindle is arranged to accommodate a tool-bit, such as a screwdriver bit or drill, when the extension is detached from the tool. Thus, the tool can operate in two modes, with or without the extension, illumination to the work region being provided in both modes.

Preferably, embodiments of the present invention can be arranged so that the waveguide output is disposed close to the receiving means. Thus, the waveguide emits light close to the work region, during use.

Preferably, embodiments of the present invention can further comprise an opaque sheath disposed over the waveguide, wherein a portion of the waveguide, including the waveguide output, extends beyond an end of the sheath. Thus, transmission of light along the waveguide can be improved by total internal reflection of the light in the waveguide. Furthermore, having a portion of the waveguide extending from the sheath provides a means for indicating whether the illuminating device is switched on.

### BRIEF DESCRIPTION OF THE DRAWINGS

Embodiments of the present invention are now described, by way of example, with reference to the accompanying drawings, of which;

FIG. 1 is a schematic diagram of a screwdriver embodying the present invention, shown in cross section; and

FIG. 2 is an exploded view of the components of the screwdriver shown in FIG. 1.

### DETAILED DESCRIPTION OF THE INVENTION

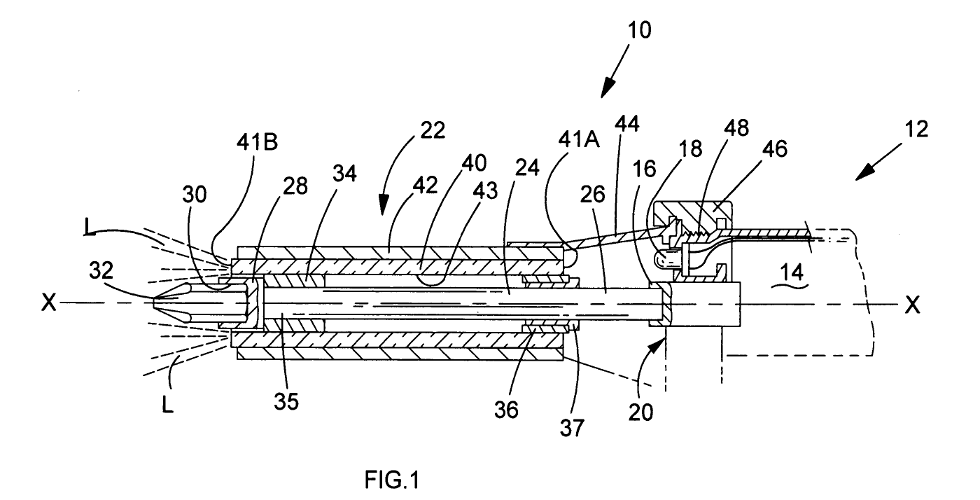

Referring now to FIG. 1, a portion 10 of screwdriver embodying the present invention is shown in schematic form. Not all components of the screwdriver are shown in FIG. 1. The screwdriver 12 comprises a gearbox 14 which has a spindle 16 into which a tool can be located. An illuminating device 18, such as an LED or incandescent bulb, is disposed on the front face 20 of the gearbox. Power is supplied to the bulb from the screwdriver's battery pack (not shown in FIG. 1).

An extension piece 22 is provided which can be attached to the gearbox housing. The extension piece is arranged to attach to the screwdriver so that its longitudinal axis is coaxial with the spindle's 16 rotational axis X. The extension piece comprises a central prop-shaft 24, one end 26 of which is locatable into the gearbox output spindle 16. Thus, the prop-shaft is driven by the spindle 16 during use.

The end of the prop-shaft 28 furthest from the gearbox has a socket 30 which is suitable to accommodate a tool-bit, such as a screwdriver bit 32. The prop-shaft 24 rotates in sliding bearings 34 and 36 located at either end of the prop-shaft. Each bearing is located between a collar 35, or 37 mounted on the prop-shaft, and a hollow tube 40 which extends over the prop-shaft.

The tube is made from transparent material, such as acrylic, and is arranged so that light from the illuminating device 18 can be transmitted along the length of the tube. In other words, the tube acts as a waveguide for light emitted from the illuminating device. This tubular waveguide 40 has a first end 41A into which light from the LED is received, and a second end 41B from which LED light is emitted. The first end of the waveguide is disposed in an opaque collar 44, which acts to constrain light from the LED and which may help to improve the intensity of light transmitted by the waveguide by improving the intensity of light entering the waveguide at 41A.

Surrounding the tube is a sheath 42 made from dielectric, opaque or non-transmissive material. Thus, the sheath acts to constrain light in the tubular waveguide 40 by total internal reflection. It may be desirable to coat the inner reflective surface 43 with the same material to further improve transmission of light through the waveguide.

Light emitted from the second end 41B of the waveguide is illustrated by dotted lines L, and is transmitted substantially along the axis X to illuminate an area which includes the work region and which is close to and surrounding the work region. In the near-field, the illumination pattern produced by light emitting from the second end 41B of the waveguide is an annulus, but as the light diverges from the waveguide's second end the intensity distribution changes and becomes more uniform and “dot-like” in the far-field. Thus, as a user brings the tool bit 32 close to the work region, from a distance, the illumination pattern changes. This can provide the user with an indication of the distance between the tip of the tool and the work-piece.

A relatively small portion (say, 3-5 mm) of the waveguide's second end 41B can be arranged to extend, or to be exposed, from the sheath 42. This arrangement has the advantage of providing a means by which the user can see whether the LED light remains on, because light which is back-scattered from the waveguide's second end is visible to a user (thus indicating that the LED remains switched on).

The extension 22 is attached to the screwdriver clam-shell, or gearbox housing, via a threaded nut 46, which is captured on an end of the collar 44. The threaded portion of the nut cooperates with a suitable threaded portion 48 on the gearbox housing. The collar is seated on the gearbox housing and secured in position by the threaded portion. Alternative attachment means might include a bayonet-type fitment in which a protrusion extending from the extension or gearbox cooperates with a socket on the gearbox or extension piece respectively.

A number of LEDs can be arranged in a ring around the gearbox spindle 16. Of course, the number of LED chosen depends upon the intensity of illumination required, optical losses in the waveguide, and the output intensity of each LED, amongst other factors.

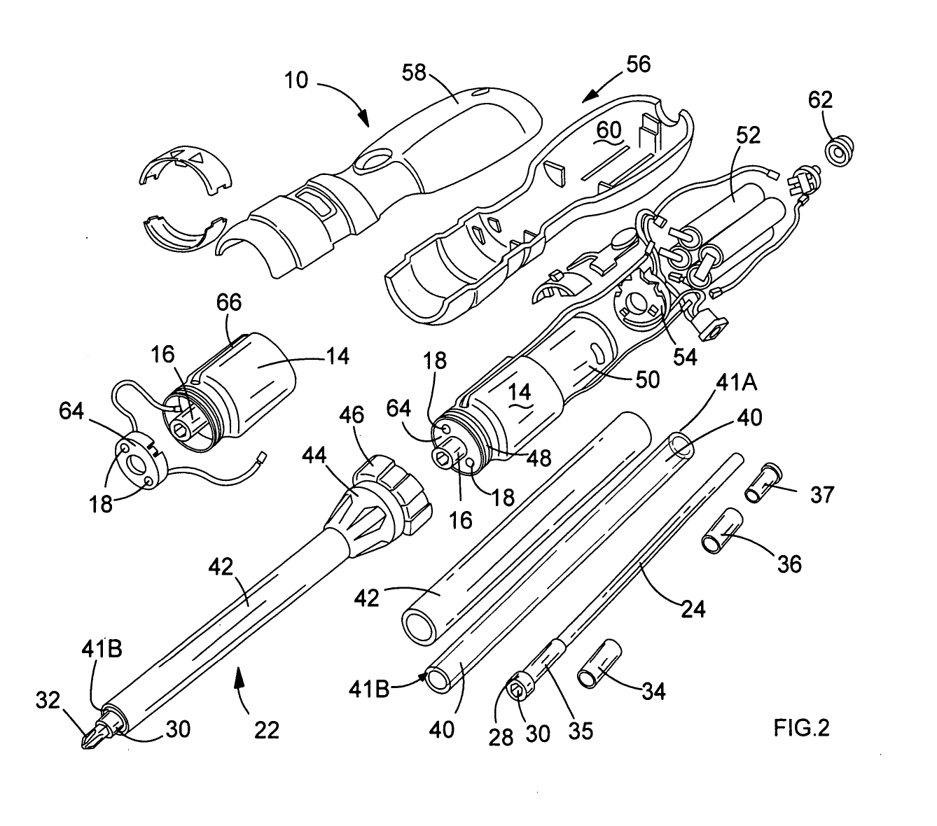

FIG. 2 shows an exploded view of a screwdriver embodying the present invention, in which components that are common with FIG. 1 have the same indication numerals. The gearbox 14 is arranged close to a motor 50 which is powered by a battery pack 52. A switch arrangement 54 is provided to interrupt power from the battery pack to the motor, thus providing a means to control the power tool. The switch can also reverse the polarity of the power to the motor so that the motor can run in an opposite direction. The battery pack also provides power to the LED illuminating device 18. The gearbox, motor, switching device and battery pack are all housed in a housing 56. The housing comprises two parts formed from injection moulding plastic components 58 and 60, and formed in a clam shell arrangement. A socket 62 is arranged to receive an electrical output from a charging unit for recharging the battery pack 52.

The LEDs 18 are arranged in an annular insert 64 which fits around the gearbox spindle 16. In the arrangement shown in FIG. 2, two LED devices are shown. However, three or more LEDs can be arranged in the annular ring, depending on the illumination level required. Electrical wires connecting the LEDs to the battery pack are arranged to run along a groove or conduit 66 in the gearbox housing.

The screwdriver is arranged to operate in two modes. In a first mode, with the extension fixed to the housing, a tool or screwdriver bit can be fitted into the socket 30 and light from the LEDs is transmitted along the waveguide so that the work-piece is illuminated by the LEDs. In a second mode, the extension piece can be removed and a tool-bit can be fitted into the socket in the gearbox spindle 16. The standard tool-bits are relatively short, and in this second mode the LEDs are therefore relatively close to the work-piece. Thus, in the second mode of operation the LEDs illuminate the work-piece without the need for a waveguide. As a result, embodiments of the present invention provide a motor-operated screwdriver which comprises illuminating devices arranged to illuminate a work region with light which is transmitted substantially along the tool's longitudinal axis X. Having the illuminating devices disposed on the gearbox housing provides means for illuminating the work region when the extension is detached from the tool, or for illuminating the waveguide input when the extension is attached to the tool. The majority, or at least a high proportion, of light which illuminates the waveguide input 41A is transmitted by the waveguide to the output 41B where it is projected to the work region. This arrangement helps reduce losses due to divergence of light from the LEDs when the LEDs are held a distance from work region, for instance when an extension piece is attached.

Other embodiments of the present invention will become apparent to the skilled person. For instance, during use the waveguide 40 and sheath 42 can be arranged to rotate with the prop shaft 24, relative to the screwdriver housing 56. Furthermore, the first, or light-receiving end 41A of the waveguide can be shaped to optimise the amount of light received by the waveguide. For instance, the receiving end might be flared to achieve this aim, or the end might have a convex shape in order to focus light into the waveguide. The length, dimensions and shape of the waveguide and/or prop-shaft can be arranged for various uses. For instance, the prop-shaft might be of the flexible kind used to transfer rotational movement through an angular displacement. In this instance, the extension can comprise a curved waveguide fitted over the shaft thereby providing a tool which can reach relatively inaccessible regions, and providing illumination of the work region at the same time (the light from the illumination device being transmitted via the curved waveguide): the waveguide and shaft might be curved through 90 degrees, for instance.

1. A hand-operated motor driven tool comprising,
a body for housing a motor arranged to drive an output, the output having an axis of rotation,
a tool bit holder disposed at a first end of the spindle furthest from the motor, and
a light emitting device (18) arranged in or on the body,
characterised in that the tool further comprises
a waveguide arranged to guide at least a portion of light emitted by the light emitting device from a waveguide input to a waveguide output, the waveguide output being arranged such that light is emitted from the waveguide substantially along the output's axis of rotation for illumination of a work region.

2. A tool according to claim 1, further comprising an extension arranged to be fixedly attached to the tool.

3. A tool according to claim 2, wherein the extension comprises the output, waveguide and a shaft, and wherein a second end of the shaft furthest from the tool bit holder is arranged to cooperate with a motor's output spindle.

4. A tool according to claim 2, wherein the extension comprises the output, waveguide and a shaft, and wherein a second end of the shaft furthest from the tool bit holder is arranged to cooperate with a motor driven gearbox output spindle.

5. A tool according to claim 3, wherein the output spindle is arranged to accommodate a tool-bit when the extension is detached from the tool, and
the spindle (16) is arranged to accommodate the second end of the shaft when the extension is fitted to the tool.

6. A tool according to claim 4, wherein the output spindle is arranged to accommodate a tool-bit when the extension is fitted to the tool, and
the spindle (16) is arranged to accommodate the second end of the shaft when the extension is fitted to the tool.

7. A tool according to claim 1, wherein the waveguide output is disposed close to the tool bit holder.

8. A tool according to claim 1, further comprising an opaque sheath disposed over the waveguide, wherein a portion of the waveguide, including the waveguide output, extends beyond an end of the sheath.

9. A tool according to claim 1, wherein the waveguide output (41B) is disposed close to, or around, the tool bit holder, thereby providing means to illuminate a work region.

10. A tool according to claim 2, wherein the extension is curved.

11. A hand-operated motor driven tool comprising,
a body housing a motor which is arranged to drive an output, the output having a tool bit holder disposed on a first end furthest from the motor, said tool bit holder being arranged to receive a tool-bit (32),
a light emitting device arranged in or on the body, and
a waveguide arranged to guide at least a portion of light emitted by the light emitting device to an output of said waveguide, the waveguide output being disposed near to the tool bit holder,
characterised in that, the waveguide and the output are arranged to rotate during operation of the tool with respect to the main body.

12. A tool according to claim 11, further comprising an extension arranged to be fixedly attached to the tool.

13. A tool according to claim 12, wherein the extension comprises the output, waveguide and a shaft, and wherein a second end of the shaft furthest from the tool bit holder is arranged to cooperate with a motor's output spindle.

14. A tool according to claim 12, wherein the extension comprises the output, waveguide and a shaft, and wherein a second end of the shaft furthest from the tool bit holder is arranged to cooperate with a motor driven gearbox output spindle.

15. A tool according to claim 13, wherein the output spindle is arranged to accommodate a tool-bit when the extension is detached from the tool, and
the spindle (16) is arranged to accommodate the second end of the shaft when the extension is fitted to the tool.

16. A tool according to claim 14, wherein the output spindle is arranged to accommodate a tool-bit when the extension is fitted to the tool, and
the spindle (16) is arranged to accommodate the second end of the shaft when the extension is fitted to the tool.

17. A tool according to claim 11, wherein the waveguide output is disposed close to the tool bit holder.

18. A tool according to claim 11, further comprising an opaque sheath disposed over the waveguide, wherein a portion of the waveguide, including the waveguide output, extends beyond an end of the sheath.

19. A tool according to claim 11, wherein the waveguide output (41B) is disposed close to, or around, the tool bit holder, thereby providing means to illuminate a work region.

20. A tool according to claim 12, wherein the extension is curved.

21. A hand-operated motor driven tool comprising,
a body housing a motor which is arranged to drive an output, the output having a tool bit holder disposed on a first end furthest from the motor, said tool bit holder being arranged to receive a tool-bit (32),
a light emitting device arranged in or on the body, and
a waveguide arranged to guide at least a portion of light emitted by the light emitting device to an output of said waveguide, the waveguide output being disposed near to the tool bit holder,
characterised in that, the output spindle is arranged to rotate during operation of the tool with respect to the waveguide.

22. A tool according to claim 21, further comprising an extension arranged to be fixedly attached to the tool.

23. A tool according to claim 22, wherein the extension comprises the output, waveguide and a shaft, and wherein a second end of the shaft furthest from the tool bit holder is arranged to cooperate with a motor's output spindle.

24. A tool according to claim 22, wherein the extension comprises the output, waveguide and a shaft, and wherein a second end of the shaft furthest from the tool bit holder is arranged to cooperate with a motor driven gearbox output spindle.

25. A tool according to claim 23, wherein the output spindle is arranged to accommodate a tool-bit when the extension is detached from the tool, and
the spindle (16) is arranged to accommodate the second end of the shaft when the extension is fitted to the tool.

26. A tool according to claim 24, wherein the output spindle is arranged to accommodate a tool-bit when the extension is fitted to the tool, and
the spindle (16) is arranged to accommodate the second end of the shaft when the extension is fitted to the tool.

27. A tool according to claim 21, wherein the waveguide output is disposed close to the tool bit holder.

28. A tool according to claim 21, further comprising an opaque sheath disposed over the waveguide, wherein a portion of the waveguide, including the waveguide output, extends beyond an end of the sheath.

29. A tool according to claim 21, wherein the waveguide output (41B) is disposed close to, or around, the tool bit holder, thereby providing means to illuminate a work region.

30. A tool according to claim 22, wherein the extension is curved.

31. A power tool extension, comprising:
an output for holding tool bit;
a waveguide for guiding light from a waveguide input to a waveguide output; and
a shaft being arranged to accommodate the output at one end,
the shaft having a second end arranged to engage with a driver output of a power tool, wherein
the shaft further comprises means to couple the extension to a body part of a power tool.

32. An extension according to claim 31, wherein the waveguide has a central longitudinal bore and the shaft is disposed within the bore.

33. An extension according to claim 31, wherein during use the shaft is arranged to rotate with respect to the waveguide.

34. An extension according to claim 31, further comprising an opaque sheath disposed over the waveguide and arranged such that a portion of the waveguide output extends beyond the sheath.

35. An extension according to claim 31, wherein the waveguide output is disposed around the output, thereby providing means to illuminate a work region.
